(19) United States
(12) Patent Application Publication
(10) Pub. No.: US 2017/0080914 A1
(43) Pub. Date: Mar. 23, 2017

(54) Air Platform System

(71) Applicant: Brian Lee Uitdenbogerd, Rosemount, MN (US)

(72) Inventor: Brian Lee Uitdenbogerd, Rosemount, MN (US)

(21) Appl. No.: 14/857,717

(22) Filed: Sep. 17, 2015

(51) Int. Cl. B60V 3/00; B60V 1/11

(52) U.S. Cl. CPC B60V 3/00; B60V 1/11; G06Q 10/02

(57) ABSTRACT

An Air Platform design is very simple concept as the multi rotor, drone technology with more powerful engines to move heavy objects with precision and speed. It uses the hardware Air Platform and the software to give instruction to the Air Platform. The Multi Rotor AirTrain patent, Ser. No. 14/698,262 design combine with Airtrain, patent Ser. No. 14/173,165 and Symmetrical Airliner, patent pending Ser. No. 14/176,397 contributed in the major source for coming up with this new patent filing of Air Platform. It is multipurpose air platform that can be replace wheels. The wheels of wheel chairs, cars, trucks, buses, trains, airplanes and even ships. Replacing the wheels with the platforms allows all things that move on the surface to glide on the flat surface like an ice puck or fly in and out of ground effects to increase the fuel efficiency with better control. Thus, the Air Platform will increase the safety and reduces the construction and operation costs of all things that is effected by the friction and that reduces different frictions.

### BACKGROUND OF THE INVENTION

AirTrain, recycling older airliner to build a ground effect vehicle concept is more of challenge than one can imagine. Lifting 50 tons metal to fly in a ground effect environment to transport cargo and people safely not an easy task.

The question remains is how can it effectively lift significant amount of weight as a size of an airliner or airliners to transport cargo and people safely? The answer is YES there is using the Air Platforms.

Using the Air Platform systems it can lift any given weight and it can operate safely and the demands from the global warming challenges we need to pursue the new technology such as Air Platforms.

When one drives a car about 85% of the total fuel you put in your car are wasted. Furth more, Co2 total emission from cars, trucks, buses and other equipment is around 79 percent. Significant contributor in our global warming and awesome disasters all over our world due to global warming.

The demand for the new ways to transport people and cargo is a priority in curving the reduction to the global warming.

One major challenges of all transportation is reduce the friction as much as possible to go faster and more efficiently travel from a point A to point B.

Co2 emission can be decreased by eliminate the friction on cars, trucks and speed rail by taking the wheels off them and replace them with Air Platform.

Take a car for example, we can use the Air Platform to reduce the many forms of friction and that equals to significant reduction in the energy savings but also it will reduce the global warming.

It can replace the wheels and tires of the cars and all other transporting vehicles. Idea is to use Air Platform to lift mass amount of weights using Air and its fluid dynamic effects using less energy and move people faster, safer, efficiently, effectively and affordable than the current form of mass transportation systems.

The Air Platform can also apply in the current and the future speed rail systems The speed trains in recent years have gained much popularity and technologically advanced. However, the cost to build the infrastructures is every increasing by the hours and it the billions of dollars. A good example is magnet-lift, speed train systems infrastructures to connect Victorville, Calif. to Las Vegas, Nev. costs estimated to be in the 60 billions of dollars. As one can see that the speed trains are nice to have but it is cost prohibitive.

This is where the Air platforms can play a significant contribution converting all things, wheels, motors and even the super magnets for the mag lifts to Air Platforms so that speed train body is lifted with the Air Platforms. A single platform or multiple platforms can be used to meet the weight lifting requirements. See FIG. 8. As one can see that applying the Air Platform technology is ideal in the speed train technology. This will help move speed trains without wheels and rails and with the faction of the cost.

Very possible that the Air Platform is safer, can travel at a greater speed, can carry two or three times more load is cheaper.

The origin of the AirTrain idea evolved into an Air Platform or Air Platforms to do the very same idea of AirTrain, recycle older airliners on top of the Air Platform for transporting people and cargo.

Air Platforms can be applied to cars and buses, it can be transformed into a cars and buses without the wheels. See FIG. 6.

Air Platform can be built to be a super transporter of people and cargo by building the Air Platform like an airliner or a ships. The difference is that Air Platform is that it utilizes the static and dynamic ground effect to effectively and efficiently control the Air Platform.

Air Platform can become a one super ship or an airliner, greater flying machine in and out of the ground effect, the wide body becomes act as a one large wing, the AirTrain platform. Or it can be a ship flying on top of the surface of water, automatically adjusting to the sea conditions and weather. The AirTrain platforms is class III Ground Effect Vehicle, it can operate in out of ground effect close to any surfaces, roads, body of water, dessert, ice and snow. At the same time it can operate at a high altitude to clear any size obstacles such as mountains. The plat form technology is the combination of airliner technology, multi copter technology and hovercraft technology. The plat forms can be a new type of Airliner or even a ground effect vehicle itself by placing canard and wings to it. Depending on the needs this new type of AirTrain Airliner or ground effect vehicle can transport 1000s of people and cargo. See FIG. 7.

The possibilities of what the Air Platform is limitless and cost effective.

### BRIEF SUMMARY OF THE INVENTION

Filed, previously and received, AirTrain, Ser. No. 14/173,165, Symmetrical Airliner, Ser. No. 14/176,397 patent pending and Multi Rotor AirTrain, Ser. No. 14/698,262, patent pending are all the concepts and technology used for building the Future AirTrain, Mass Transport Ground Effect Vehicle (MTGEV).

The Air Platforms are made of strong frames and attached are newly designed powerful engines with air intakes and air out with the tough light skin sucks on it outside to protect the inside engines and make it more aerodynamic outside. If possible the engines can be using the free energy or have independent power supply inside of the Air Platform.

The forced air from the engines will forms to take off vertically and thrust forward just like the airplanes or create a pressure differential to create lift. See FIG. 4.

The idea of Air platforms is to replace all things on wheels to move without the wheels, for example, turning a normal car into wheel less, frictionless vehicles.

The platform concept is to improve on the previous concept of the AirTrain, Multi Rotor AirTrain concept. Ground effect vehicle transforming into a platform concept with Multi Rotor, Hover Craft technology using new type of powerful internal engines and controls. These Air Platform can move smaller lighter items such as wheel chairs, pallet movers, cars, trucks and buses to can move large Airliners that are in 50 tons plus.

The each Air Platforms will be unique and it can be custom made for the specific tasks and the environment it will operate and the size and the power are considered in building these Air Platforms. See, FIG. 5.

The Air Platform is multi copter with the most highly advanced drone technology, with the more powerful engines with the surface skin covered outside.

It has the most advanced drone technology. The built in vertical engines are used for vertical take offs, ground effect adjustments, balance control, functions and controls of an airplane, close surface high pressure air lift capability.

The skin of the Air Platform, is light weight material but strong and will help float in water.

Multi self-contained fan engines, meaning it can be more than one fans inside of the self-contained engines. See FIG. 4, 9.

It can have one self-contained fan engines to multiple depending on the requirement on how the Air Platform will be used.

For large plat forms and if requires a directional control it needs to have two or more self-contained fan engines. Four self-contained fan engines are ideal for all directional controls and for the required power to lift its weight.

The self-contained fan engine requirement is determined and placed that are best for the total balance, performance and efficiency for the purpose it is designed to use it for.

The fans inside of the self-contained engine can be any size or shape, location that is will give the most balance and effectiveness.

The self-contained vertical engines are in constant communication with the horizontal engines or other controls to maximize the flight conditions.

The vertical and horizontal engines are perfectly in sync to control the speed, just like a car, it can even stop and hover with precision.

The clusters of sensors are constantly scanning and giving feed backs to the processors to make automatic adjustments required to complete its tasks.

The Air Platform with the engines inside suited for operating at a low altitude in the ground effect at the same time provide more than adequate power to lift any weight it is design to lift even two airliner fuselage on top. See FIG. 6.

The Air Platforms can do a vertical takeoff, speed at any desired setting, it can slow down to any speed, and dead stop. Constant adjustment to the local flight and weather conditions.

Air Platform is used for altitude hold safely maintaining the set, to maximize the ground effect distance and go in and out of ground effect to maximize the fuel efficiency and best utilizes the flight conditions.

Air Platform can do GPS hold at any altitude and locations safely at anywhere. It can hold at desire altitudes hold as needed and even do a GPS hold it would hold it desire altitude and at a GPS point at any time and during all adverse weather conditions. Air Platform uses algorithms to learn the new requirements of the surrounding environments and automatically adjusts its conditions to complete its mission safely and effectively.

The Air Platform frames are light, strong material and floating materials so it can land at any surface including the water for any emergency landings and take offs.

The 2. Frames are placed using the ladder principle to best support the propellers its effectiveness and efficiency.

Horizontal engines can be a jet, turbo prop or any type of engines that is most effective in operating at any altitude to provide the optimal forward trust.

Horizontal engines are mounted where it will give most forward thrust working with the quad copter to give most efficiency and effectiveness.

Airplanes parts such as elevators and rudders can be added on the Air Platform to increase the control function but also it can serve as a backup.

The winglets will have both pointing down and up. Winglets up will give a better lift performance but also increase the lift in a ground effect conditions.

Air Platform is the most technologically advanced flying machine easy to operate.

It can even use a computers or smart phones to plan execute its routes.

Air Platform executes signed tasks but learns a new ways using its algorithms.

Air Platform has the master and slave function so programing the master using a smart phone or a computer, all other slave Air Platform will automatically follow the directions from the master.

Air Platform can be programmed locally by pilots before their scheduled departure or it will be monitored and controlled remotely from a multiple points to control and monitor the Air Platform performance, control and its movements its planned travel.

The Air Platform is constantly monitoring its flight conations. If any conditions that it detects, it can warn and automatically take the safety measures. If it has to finding a safe area to land itself until the problem solved.

The super Air Platform that has its cockpit and it can be flown by pilots will have pilots to control Air Platform manually, incase if the digital systems fail. See FIG. 7.

If the digital or analog systems fail or any major controls and parts fail or unsafe is detected, it would safely land. The system can detect and warn the pilots and maintenance crew exactly what it is needed to correct the problems.

The Air Platform automatically check the balance and weight on the platform so, if any critical loading imbalance or over weight, it will not move until the problem is resolved.

Air Platform using it for the purpose moving products on a heavy pallets, it need to be capable of lifting heavy weights meaning it needs to be strong and heavy duty.

### BRIEF DESCRIPTION OF DRAWINGS

FIG. 1, Air Platform Top View.

FIG. 2, Air Platform Side View.

FIG. 3, Air Platform Bottom View.

FIG. 4, Air Platform Inside view.

FIG. 5, Air Platform Function.

FIG. 6, AirTrain.

FIG. 7, Super AirTrain or AirShip.

FIG. 8, Car with Air Platform

FIG. 9, Air Platform Speed Trains

### DETAIL DESCRIPTION OF THE PREFERRED EMBODIMENTS

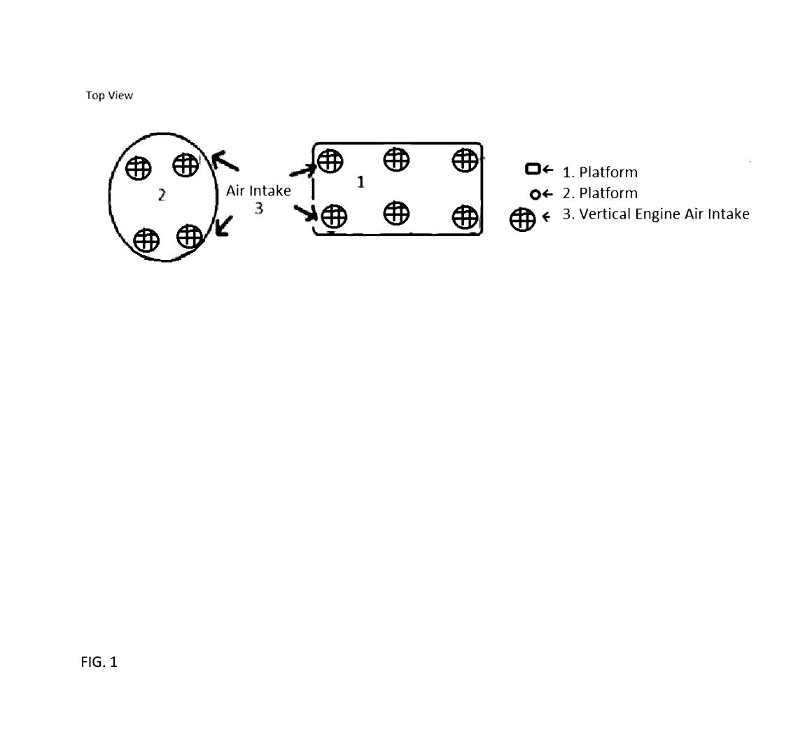

FIG. 1, is the top view of the Air Platform looks like. 1 and 2, the size, shape, and engine power, internal programs would all depend on how the Air Platform will be used. The air for the vertical engines 3 can be in any size or shape or form with proper cover. 3, the air intake can be on the side instead of the top. The air intake on the Air

Platform will be dictated by the purpose of its functions. The top surface can be a solar panels to generate free energy.

The solar sheets can be code it with a tough thin plastic to protect the solar surface. So it can endure the scratches.

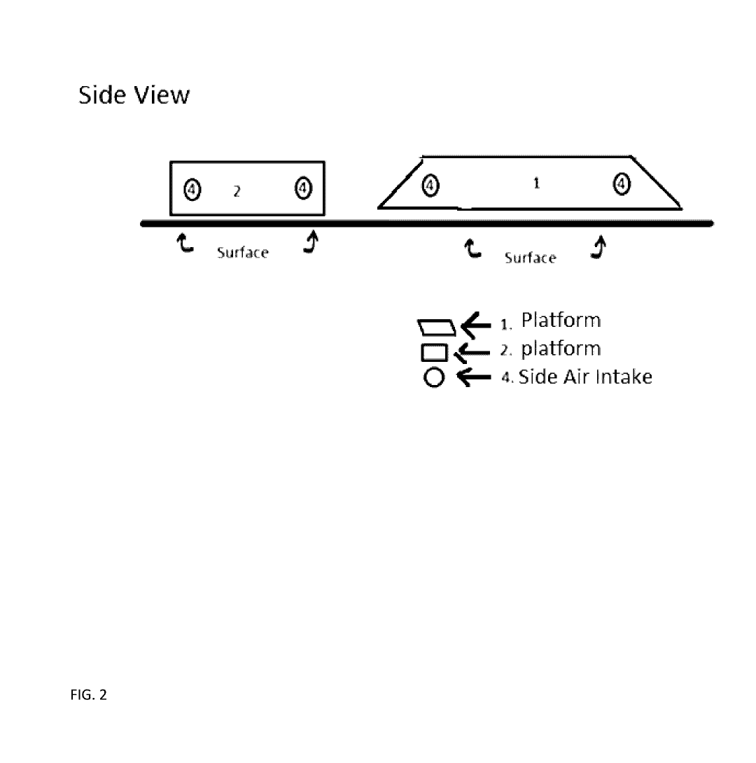

In the FIG. 2, the side view of the Air Platforms does not need to be in this shape it can be in other aerodynamically shaped for speed. Again the purpose the Air Platform be used for dictates to the size, shape and form. 4 is side air intake. The skin of the Air Platform are light, strong material designed like a sock to cover the frame and to protect all the things inside of the Air Platform.

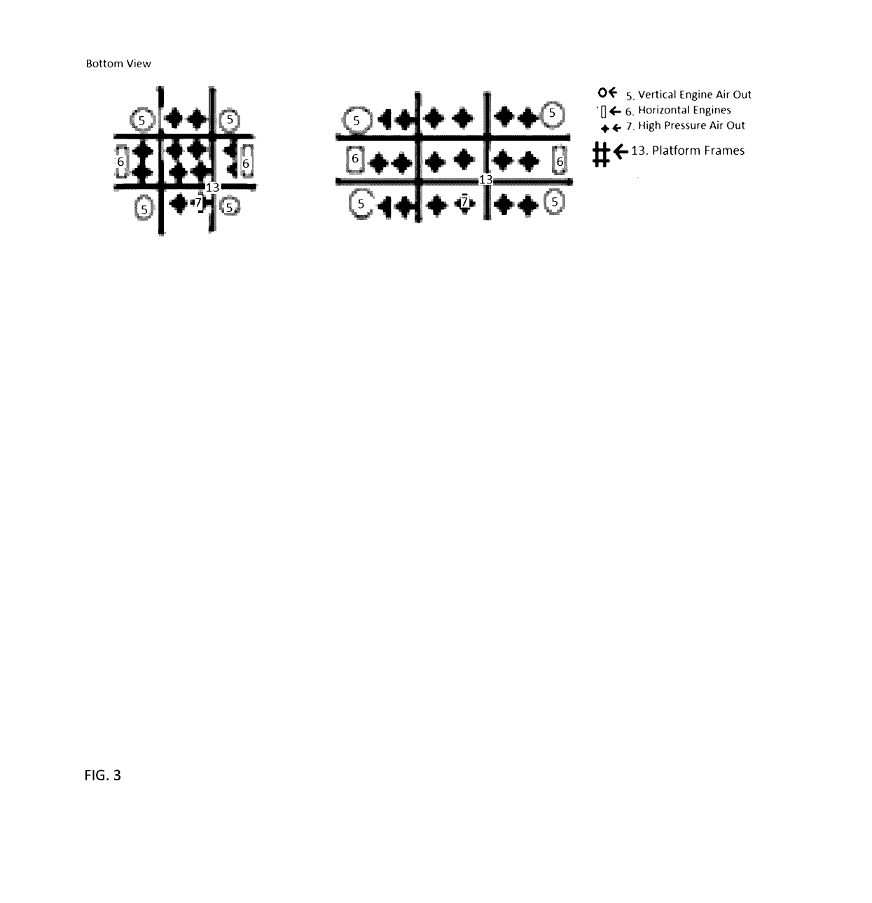

In FIG. 3, bottom view of the Air Platform 5 vertical engine air out, the thrust is created for vertical take offs, altitude holds, for control, all turning movements, altitude holds. When required, the 5 vertical engine and 6 horizontal engines are in constant adjustment to give a best performance in ground effect and the work task it is signed. 7 high pressure air out can be used for lifting heavy objects and for better control over the surfaces. 13 is the platform frames is the back bone of the Air Platform, light and strong material, ladder shaped and the engines can be easily attached and removed from it.

Horizontal Engines can one, two or more, best locations to integrate to vertical engines to give its best performance, effectiveness and efficiency's. The source for the high air pressure air out can be from the horizontal engines or vertical or both the directional control.

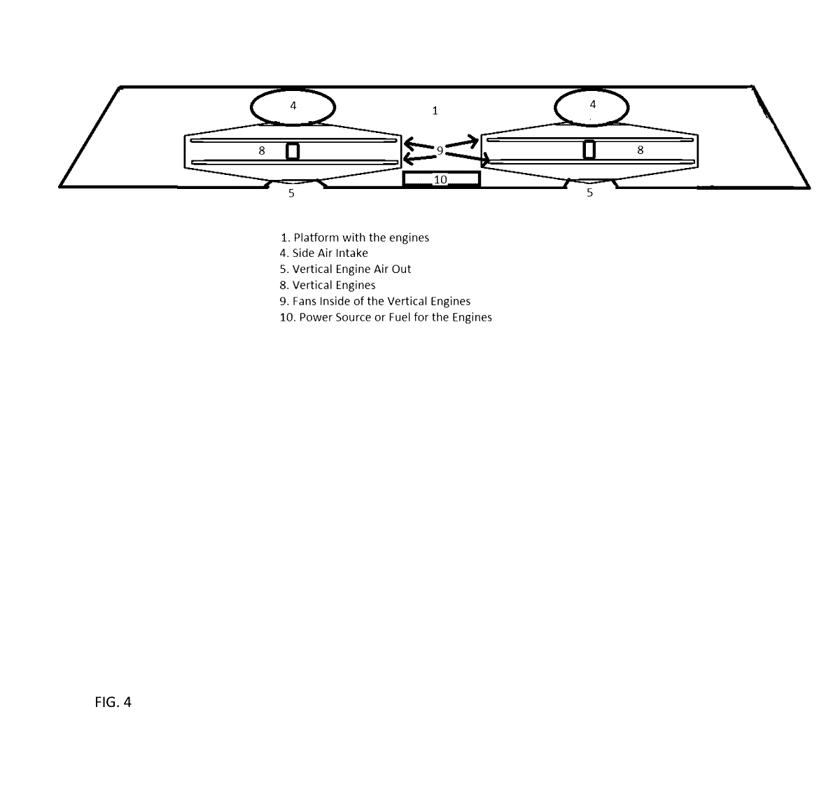

In FIG. 4, Air Platform inside. The Air Platforms are simple, it is a frame with built in engines and the power source. Some cluster of sensors and processor to control the engines to do what you want it to do. It is a drone with very powerful horizontal and vertical engines depending on how the Air Platform will be used. 8, vertical engine or engines in a platform. If using one engine, it would use the gyro effect to keep it stable.

It can use other wire system to move the controls for the directional controls. Ideally it is best to have more than four vertical engines. This is better for the stability and control. The vertical engines working with cluster of sensors are constantly scanning and give and receive feed backs of the flight conditions and its surroundings.

This would give the Air Platform the complete control of the directions. 9 the fans for the engines can be in multi-layer for whatever it takes to meet the power requirement for its job.

The power source can be free energy or combination of things. If it is electric, the batteries can be used for storing the energy. 4 the air input for the vertical engine can be from the sides. 5 is where it will let out the powerful engine air out, trust.

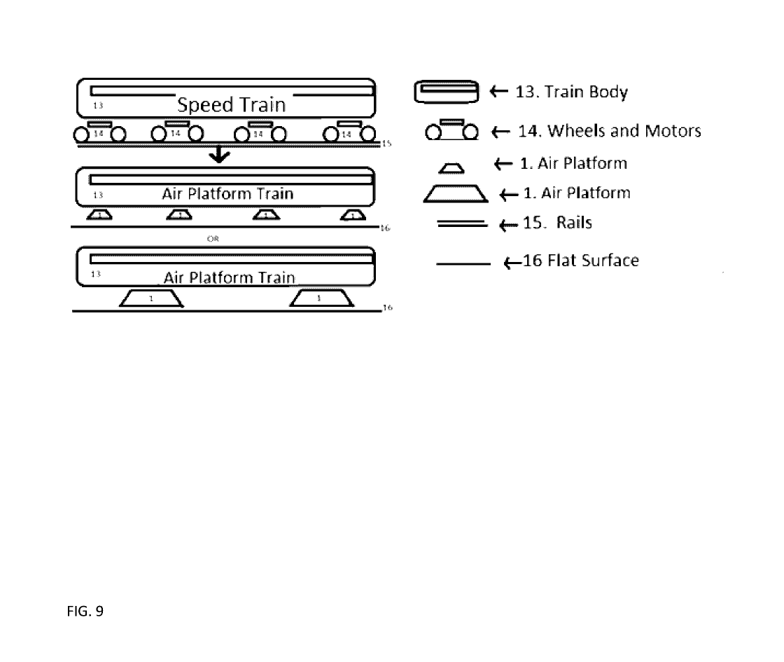

The software and the programs are uploaded to each Air Platform or it can be uploaded directly to the vertical engines, 8. If there are multiple Air Platforms involved, each vertical engines can work with other engines, making constant adjustments it requires or the Air Platform are used to make required adjustments. In any case, of the central control and decentralize controls of the Air Platform, the ultimate outcome is to make the Air Platform to do what is design to do with safety and backup functions. The Air Platforms have to work together, one master program can run all the other individual Air Platform to work together. For example in the FIG. 9, the speed trains with the multi Air Platforms.

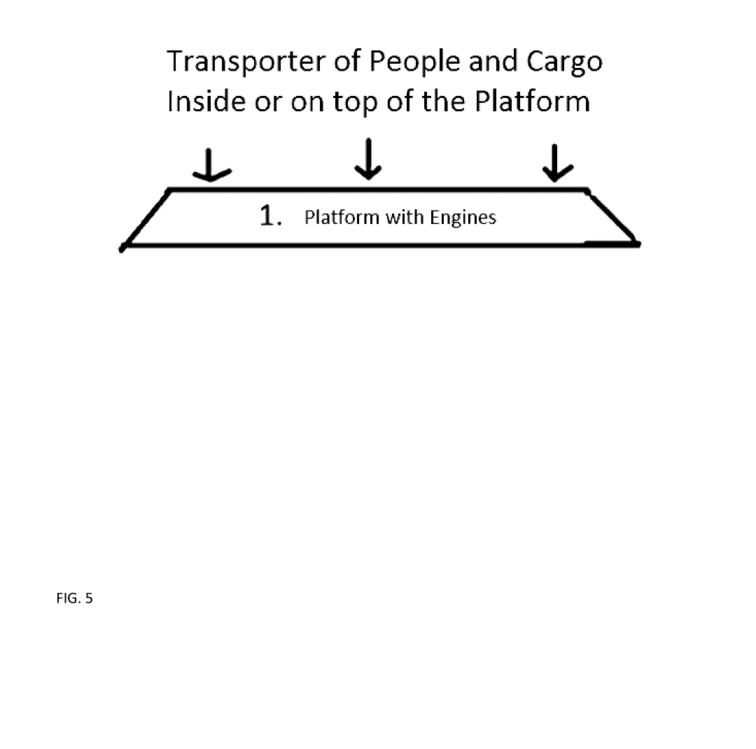

FIG. 5, Air Platform is a complete system, like a drone, like an airplane. It will do all the tricks plus more with the built in heavy duty engines to lift heavy things. How it will be used will dictate what equipment will be installed. Want to do you want to move, how and where. Air Platforms are fitted with different functions and equipment for the different use in the different environment. For example lifting an airliner and flying it in ground effect over water will be different than flying over the land or even moving small items such as moving a wheel chair with a person on it. What do you want to move and at what speed. The platform sizes and capabilities will be matched with its equipment inside.

The people and things can be moved on top or inside of the Air Platform. Than the Air Platform becomes the super mover by itself. See FIG. 5.

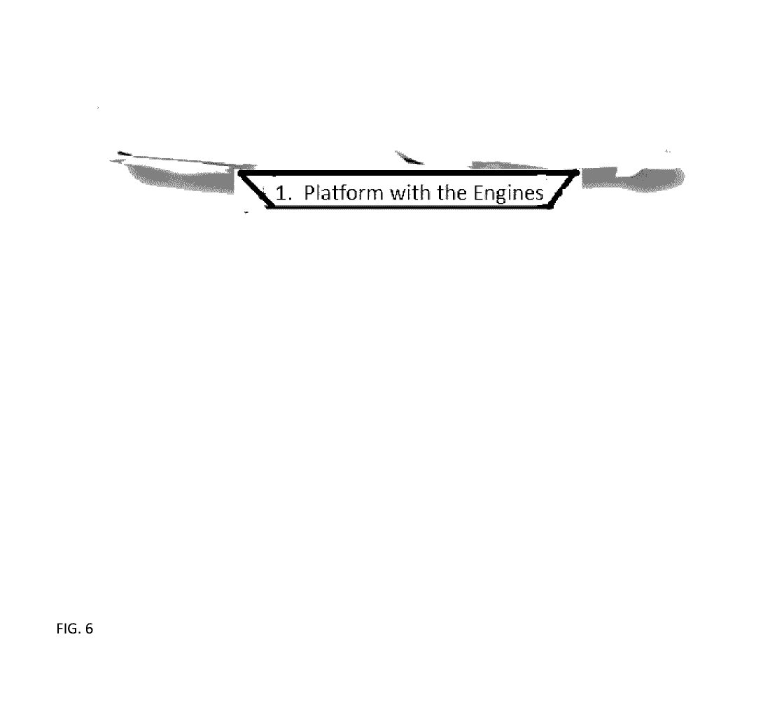

FIG. 6, Using an Air Platform or Air Platforms to move an airliner or airliners. Recycle an old airliner to fly converting them to be a ground effect vehicles to transport people and cargo.

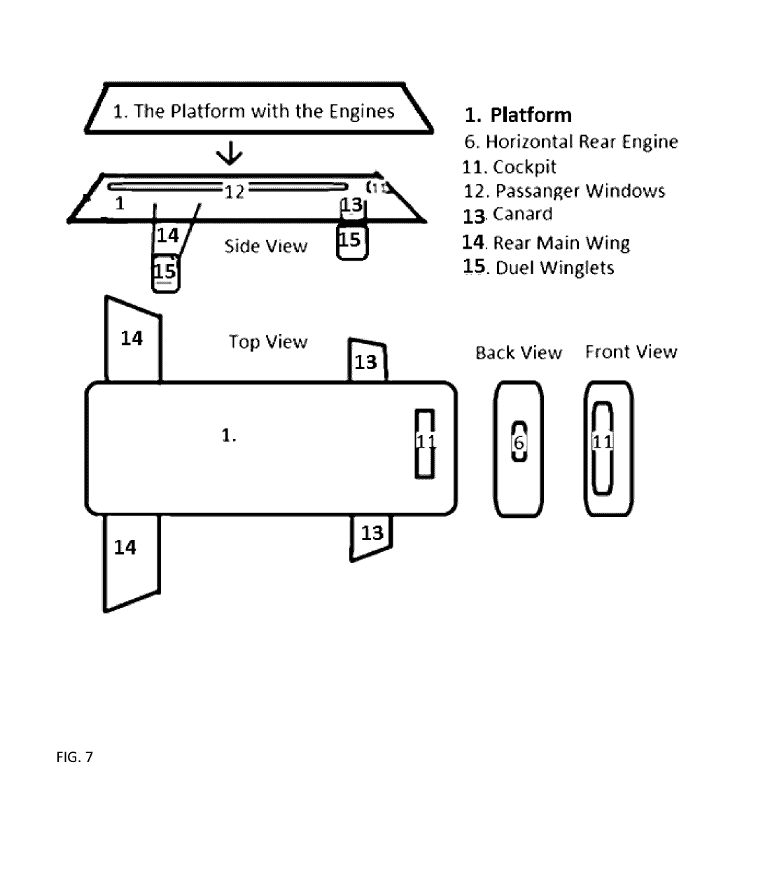

FIG. 7, the Air Platforms can be super-sized, larger than the biggest airliner exist in our world. It can be used for transport people and cargo. It can fly like an airliner but also it can fly in ground effects to increase the fuel performance. The Air Platform can be used in the waters to transport cargo and people. Making the sea travel faster and with more comfort.

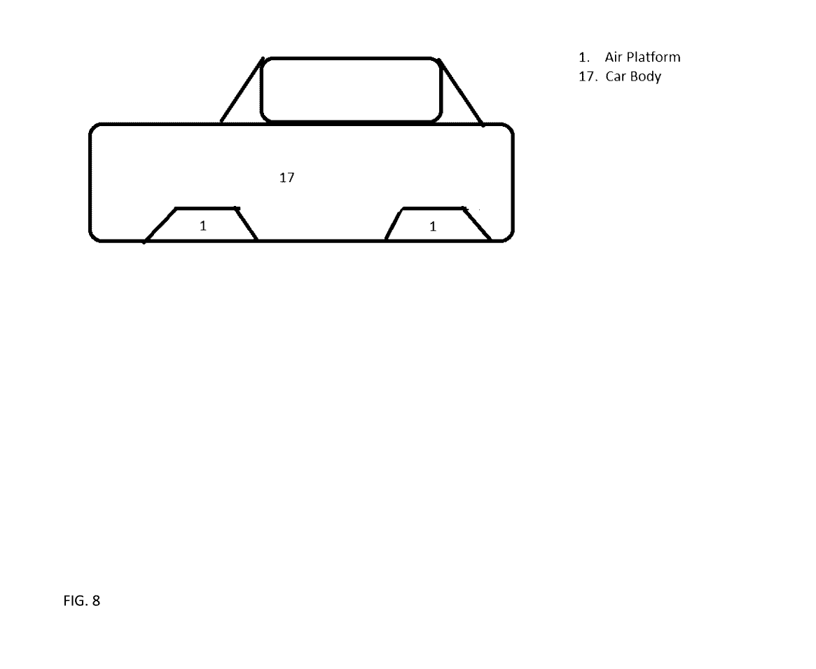

FIG. 8, On a smaller scale, the Air Platform can replace the tires and wheels of a car. The four Air Platforms can replace four wheels and move it without the main engine. This will reduce the lubrication friction as well.

FIG. 9, using the same idea but applying them on a bus or on speed trains. Just using the body combining with the Air Platform, the Air Platform can provide the power, control and speed of the speed trains. This way it will eliminate the costly infrastructures and the power source.

### INDUSTRIAL APPLICABILITY

We live in a digital age. The digital, computers, smart phones and applications that runs the programs to make our lives easier, faster, cheaper, are part of our daily life. The digital age is here and our advance in the digital technology is transforming how we live, work and play. In the communication business, we have gone from analog phones to a digital smart phones. The smart phones with the applications we can reach out to communicate with the world with a single swipe.

The transportation is no different. It made much progress like the smart phones but still the world demands more change. With all technology it has its own obstacles to overcome. In the transportations is how to effectively overcome the friction and the gravity. In our life time, we pushed with powerful engines to push through the air to keep the airplanes in the air. In the future the focus will be how to overcome the gravity, friction and how to use free energy. How we can travel faster, smarter, greener and efficiently.

Building faster, smarter, effective and efficient transportation system that is faster than the current airliner, speed trains and cars. This is how the concept of the Air Platform is born from the idea of creating an AirTrain recycling the older airliners converting them to speed trains to run in a ground effect without any barriers and infrastructures of any sort. A transformation in the idea of how the trains have to be on a track or some sorts. From the AirTrain idea the Air Platform is born, a simple platform drone technology, transforming it to be a multipurpose people and cargo mover by replacing the physical things that wastes energy due to frictions, for example the tires on the cars by replacing the tires with the Air Platforms.

The Air Platform idea is just a start and we can build on it as we dreamed of faster computers. As the new technology develops the Air Platform technology will grow with it.

Air Platform is a simple hardware, heavy lifting device. As a smart phones need a good applications, the Air Platforms needs applications too. The Air Platform potential for what it can do is endless with the right application uploaded to the Air Platform and using it together it can create and transform the current transportation systems. As the smart phones did to our civilization, the Air Platform will open new opportunities in how we think about how we travel in our wheel chairs, how we move things from place to places, automobiles, trains, airplanes and even ships on the sea. These changes are coming and we need to embrace and develop this new concept, Air Platform to transport people and cargo faster, safer, effectively and efficiently.

Our world demands new changes with all the Co2 emissions and the global warming that we are causing right now. With the development of Air Platform we are confident we can help reduce the global warming and make the transportation to be more safe, fun, enjoyable and economical.

AirTrain, train without a barrier, infrastructure and electricity to power and the speed of speed trains can be done using the Air Platforms. Idea of moving things safely with the precision is a dream for the man kind and it will continue.

A person on a wheel chair wanting to move freely, moving pallet full of heavy equipment using the Air Platform to transforming cars to airplanes by replacing the wheels to Air Platform.

On the same note, it can transform speed trains to move on Air Platform, even airliners can be equipped with Air Platform to eliminate the dangers of the ground effect related accidents. Giving the Airliners and all airplanes the vertical takeoff capability. Air Platform can work in a hover crafts for the increase performance in the lift and control. Air Platform can be a super airliner or a ship, transporting people and cargo on top of the plat form or inside of it.

The Air Platform can replace all things that move on wheels with Air Platform to reduce the friction and using it to reach the remote places where a conventional travel does not allow. For example, a remote place in a forests.

Air Platform will transforms how we travel in the future in the air, land and sea. Air Platform industry capability is unlimited as to how it can be used in the future to meet our transportation needs.

### CITATION LIST

### Patent Literature

U.S. Pat. No. 7,9000,865 B2 Mar. 8, 2011, Moore, Boren and Marques

### Patent Pending Arts

patent Ser. No. 14/173,165, Art Unit 3644
application Ser. No. 14/176,397, Art Unit 3617
application Ser. No. 14/176,397

### Non Patent Literature

International Journal of Scientific & Technology Research Volume 3, Issue 8 Aug. 2014, titled Quad copter Flight Dynamics by Mohd Khan.

1. The Air Platforms system have two parts, the hardware, and the software.
The Air Platform Software, using it to give directions to the Air Platforms.
The Air Platform Software and the hardware are inseparable and it makes the Air Platform a complete system. An idea of using a programs to communicate with Air Platform devices to life that it can be programed as a single system or work with unlimited of other Air Platforms to work together to complete a signed tasks.
The Air Platform software, the programs are very important part as it is, performing the signed tasks, monitoring the progress, the planning the future performance, working with the cluster of sensors to detect and making adjustments required to perform signed tasks as one Air Platforms to multiple platforms to achieve the signed mission safely and effectively until the mission is completed.
Software can be very simple or very complex depending complexity of the instruction it is giving to Air Platform or Air Platforms.
The Air Platform can work alone or it can work with other 100s or even 1000s of other Air Platforms to achieve the task it is given.
It can be a simple instructions to very complex instructions with multiple tasking to analyzing using the on board sensors and external sensors.
The each sensors performs specific tasks or multiple. A cluster of sensors are receiving and sending information do calculation at a fraction of the seconds and new instructions sent out to the hardware Air Platform or Air Platforms its mission, safely, effectively and efficiently. For example, FIG. 8, the car with the four Air Platforms would be able to set a start point and finish point from a smart phone, it would do all the functions, speed and minding the safety concern until it arrives in its final destinations or ask for more information to complete its given mission safely.
The software can be programed as a master and slaves. In a more than one Air Platforms are involved, giving an instruction to master Air Platform, it automatically feeds the required instruction to the slave Air Platforms.
The communication between the master and slave is ongoing and constantly updating the information, calculating and making its corrections.
The communication between the Air Platform and the software, master and slave are automatic.
The slaves' are capable of computing and making its own decisions to in sync with accomplishing the common mission.
The Air Platform software incorporate algorithms to learn teach the hardware, Air Platform to understand the conditions and take appropriate measures.
The cluster of sensors to give receive and give constant correction to improve the performance on its own or follows manually given commands.
It does automatic diagnostic test periodically to check the tear and wear on the Air Platform and ensures that all the proper preventive maintenance and the corrective maintenance is met.
Air Platforms rejects any commands given that is violates the hazard to the Air Platforms and the safety of a passenger or the people.
The remote monitoring of the Air Platform can be monitored at multi-different locations or one central locations.
It can monitor the performance of the each Air Platform and automatically corrects what it needs to correct or if required, manually corrected remotely.
Use of the applications the other people, passengers with the permission can monitor the progress of the Air Platforms locations and estimated time it will pass through the preset route. This application can be to reserve purchase seats of an AirTran that uses the Air Platforms to operate and so on.
Engines are unique itself. It uses the flying saucer engine concepts with the built in large fan or fans to push large amounts of air from a single air inlets to a multiple air inlets to generate trust and creating the difference in the pressure. See, FIG. 4. The source it requires to drive can be a free energy or combination of motors and energy source to provide the required power.
The vertical engines give the vertical thrust.
Horizontal engines provide the horizontal thrust. The horizontal engine can also be similar to the flying saucer type but also can be conventional Airplane engines depending on the mission and the purpose the Air Platform is designed for.
The vertical engines and the horizontal engines or any other required engines, they are constantly monitoring each other's performance and working together to achieve the required tasks and the mission especially it is in a ground effect environment.
The cluster of sensors are all around outside and inside of the Air Platform, monitoring the Air Platforms of its performance but also the environment it is operating from. The sensors receives and sends important data for the Air Platform to make the appropriate changes during its operation throughout its performance.
On board cameras and programs can serve as another form of sensors for improving and adjustments required to make the appropriate changes during its operations. Also, the performance can be monitored. Also the progress and Air Platform positions and angle can be monitored using cameras. The usage of the cameras can monitor leaks and monitor the sensors using the cameras.
The applications, the many applications can be made for the Air Platforms that can be used with the smart phones or computers.
The frames of the Air Platform is made of light but strong materials that are available and it is reasonably priced. The frames will be put together as a ladder type, see FIG. 3, 13. The frames are the back bone of the Air Platform but also it provides a place for attaching engines and other devices to it. For example, self-inflatable devices inside of the Air Platform in case it needs to make an emergency landing in the water. Another example is that it needs to make an emergency landing from a high altitude and need to open a parachute for high operating Air Platforms.
Skin is the outer later that is fire retardant, strong, but flexible and light weight. Some part of the outer layer can be covered with solar cell sheets for some free energy. The outer later, the skin can be designed like a sock, it will side on like putting on a sock. The Air Platform is simple in device but can do complex things. It helps lift heavy things and move with precisions working Air Platforms in groups or a single one.
The Air Platform is designed to reduce the friction of all moving things, eliminating the wheels. See FIGS. 8 and 9.
The Air Platforms can eliminate trains from operating on the infrastructures or other barriers. Thus, it can save billions of dollars in the construction costs and maintenance costs.
The Air Platform can combine with other vehicles to transport people and cargo. The Air Platform can operate in and out of ground effect for the most optimal fuel efficiency and for its mission.
The Air Platform is easy to build, strong, powerful, intelligent, easy to use, easy to integrate, and easy to maintain.
The Air Platform can decentralize the power by each Air Platform providing power, it is better than the four wheel drive, provide the adequate power from each Air Platform and not like a car engine that provides power to all the wheels. Thus it is more efficient and never have to worry about getting a flat tire. See FIG. 8.
The Airbrakes can be used to slow down the speed of the Air Platform that is performing high speed tasks. Or using the combination of the Air Brakes and the engine brakes to slow or stop.
Also maintain its position avoiding other objects, people or the things that is a safety hazards and dangers.
The Air Platforms are easy to build and easy to maintain. Easy to integrated for the different use, but need to and must meet the power requirements and the programs it requires to do the complex monitoring and movements it is required to do.
The Air Platforms are cheap to mass produce and can it can be used for recreation uses as well. With the Air Platform we do not need to build a car airplanes. Just drive up your car on to an Air Platform and simply tell it what to do using ones smart phone.
Airplanes can fly safe by adding the Air Platform to it, it can do vertical take offs and the Ground effect is a condition all airplanes is controlled and it can use for its benefits.
The power for the Air Platform can be a form of battery, bio diesel, fossil fuel or any other means that is economical for the Air Platform.
In FIGS. 8 and 9, the power supply can be the actual road that as the plat form passes over it, it can charge back or give power to the Air Platform. It is like the toy race car or toy electrical trains. The entire road does not have to be the charging stations but some parts to charge back the power used.
